(19) United States
(12) Patent Application Publication
(10) Pub. No.: US 2022/0362655 A1
(43) Pub. Date: Nov. 17, 2022

(54) Method and Apparatus for Distant Location of an Object

(71) Applicant: CapTech Ventures, Inc., Richmond, VA (US)

(72) Inventors: Charles A. Williamson, Richmond, VA (US); Arjun Baradwaj, Atlanta, GA (US); Vincent Brett Schoenfelder, Midlothian, VA (US); Clinton Teegarden, Springfield, VA (US)

(73) Assignee: CapTech Ventures, Inc., Richmond, VA (US)

(21) Appl. No.: 17/740,455

(22) Filed: May 10, 2022

Related U.S. Application Data
(60) Provisional application No. 63/187,543, filed on May 12, 2021.

(51) Int. Cl. A63B 71/06; A63B 24/00

(52) U.S. Cl. CPC A63B 71/0622; A63B 24/0021; A63B 69/3691

(57) ABSTRACT

The present method and apparatus capture the position of a golf ball on a golf course consistently and accurately using consumer-grade, affordable technology. The output provides the latitude and longitude of the ball along with, optionally, additional insights including surface type, club, stroke, penalties, etc. Accuracy can differ slightly depending on location but is typically within a matter of feet. For example, the rough may be less accurate whereas the greens should be very accurate. This method and apparatus utilize 3-5 trackers, typically volunteers, per hole to capture shot-level data while leveraging commercially available smart devices and range finders.

This application claims the benefit of filing of U.S. Provisional Patent Application No. 63/187,543, filed May 12, 2021, which is incorporated herein in its entirety.

The present invention is directed to an efficient, affordable and relatively simple method and apparatus for accurately identifying a location of an object while being distant from that object. In one example described herein, the method and apparatus are deployed to accurately identify the location of a golf ball on a golf course while the tracker is positioned remote from that golf ball.

### BACKGROUND

The game of golf is believed to have started in the 15^{th} century. While innovation is not new to the game, it has primarily focused on a golfer's equipment. From improving the club and ball technology to introducing range finders and score keeping, the game of golf has indeed changed. To continue to evolve the game and draw in new participants, technology must enable the next gen golf experiences. The introduction and evolution of data into the game has had a remarkable impact.

On the market today, there is a plethora of physical devices that can capture object location and provide a distance to an object location, but there is no solution that does both without having to be at the exact location of, for instance, the ball.

Historically, current companion applications in the golf space are pure scorecards. Golfers finish their hole and mark down their score, as if it was a physical paper scorecard. Unfortunately, that means that those golfers do not have a way to look back at their shot locations and distances after the fact. During a round, they may use a rangefinder to calculate distance to their next shot and do mental math to understand the distance from their previous shot, but that data is not stored off or synced anywhere to tie it back to their hole performance. Some competitors in the golf world like The Grint®, SwingU®, and 18Birdies® utilize a GPS-only approach. A GPS-only approach requires a player to stand precisely next to the ball and log it in their smart device. In the course of competition play, however, GPS mobile apps are either banned or a deterrent to the rhythm of a golfer's game. Other solutions on the market today requires significant resources and investment per event/course in terms of physical hardware/technology.

### SUMMARY OF THE INVENTION

The goal of the present method and apparatus is to overcome the foregoing shortcomings and to capture the position of a golf ball on a golf course consistently and accurately. The output provides the latitude and longitude of the ball along with, optionally, additional insights including surface type, club, stroke, penalties, etc. Accuracy can differ slightly depending on proximity to the ball but is typically within a matter of feet. Using affordable, consumer-grade technology, this method and apparatus may utilize one tracker, typically a volunteer, per hole to capture shot-level data while leveraging commercially available smart devices and range finders.

The method and apparatus aim to achieve comparable performance without the cost, operational challenges and resource needs of other products on the market today. The only equipment needed is a smart device with dual frequency GPS and compass capabilities and a rangefinder. Cellular connectivity or WiFi can upload data about a shot location directly to a cloud database. The following of a player's performance on a golf course can be used in gaming and gambling applications.

The method and apparatus are relatively simple enough and inexpensive to deploy. These attributes make systems like those described here available for professional golf organizations, college and junior golf teams and events and even individual club tracking of members or players generally.

In one example described herein, a method of accurately presenting the latitude and longitude of a golf shot location comprising the steps of providing a smart device that is GPS-enabled, has an internal compass, has a user interface, and comprises a processor that uses geocoordinates and distance measurements to calculate accurate golf ball location; providing a rangefinder; providing a tracker; during a golf game, after a player hits a golf ball on the golf course; identifying the latitude and longitude of the tracker on the golf course; measuring the distance between the tracker and the golf ball on the course using the rangefinder; obtaining the compass bearing in degrees from 1 to 360 between the ball and the smart device as measured by magnetic north using the compass in the smart device; calculating by the processor the magnetic declination angle of the tracker between geographic north and magnetic north based on the known latitude and longitude of each of the geographic north, the magnetic north and the location of the smart device; calculating by the processor the geographic bearing of the ball from the smart device by combining compass bearing and magnetic declination; calculating by the processor the latitude and longitude location of the ball by using the distance of the ball and the geographic bearing of the ball from the smart device; and displaying on the user interface of the smart device the latitude and longitude location of the golf ball. The method may further include the step of transmitting by the smart device the golf ball location to a central data collection processor. The central data collection processor may be proximate the golf course or remote from the golf course. The calculated latitude and longitude location of the golf ball may be visually displayed to the tracker and approved by the tracker before the location is saved. The rangefinder and smart device may be separate physical components or they may be a single component. The rangefinder and smart device may be mounted on a monopod. The smart device may include an application that displays to and prompts the tracker to complete tasks during the method steps. The tracker may follow a single player around the entire golf course and saves the ball locations of all of the shots for that individual, the tracker may follow a plurality of players around the entire golf course and saves the ball locations of all of the ball shots for each player in the group, and the tracker may be stationed at a single location on the golf course and record the golf ball location of the shot of all the golf players proximate the single location. The tracker may be a human or a robot. The processor may have a map of a golf course stored therein, and the golf ball location is displayed on the map of the golf course.

### BRIEF DESCRIPTION OF THE DRAWINGS

FIG. 1 is a schematic representation that illustrates the operation of a golf shot tracker process as explained herein.

FIG. 2 is a perspective view of a rig including a rangefinder and smart device that may be used with the process described herein.

FIG. 3 is a side, schematic view of different measurements for measuring distance from a rangefinder to an object.

FIGS. 4A and 4B illustrate an example of user interface screenshots that could be used with the process described herein.

FIG. 5 is a flowchart illustrating the functionality of steps that may be used in connection with an example of the process described herein.

FIG. 6 is a top schematic view of a golf ball on a golf course showing the location of a tracker and the ball.

FIG. 7 shows the same tracker and ball as in FIG. 6 but with the distance to the ball shown.

FIG. 8 shows the same tracker and ball as in FIGS. 6 and 7 also showing the compass bearing of the ball versus the tracker.

FIG. 9 is a drawing of the globe illustrating difference between magnetic north and geographic north.

FIG. 10 places the tracker on the map of FIG. 9 and the difference in relative location versus magnetic north and geographic north.

FIG. 11 illustrates the golf hole in FIGS. 6-8 also illustrating the magnetic declination in order to accurately locate the golf ball by latitude and longitude.

### DETAILED DESCRIPTION

As explained earlier, the present method and apparatus, alternatively referred to herein as a system, enables a tracker to accurately locate the latitude and longitude of a golf ball on a golf course without having to stand over or directly adjacent the ball. This system may be also deployed in other applications where a remote tracker can obtain an accurate location of an object with the only requirement being that the tracker can visually see the object.

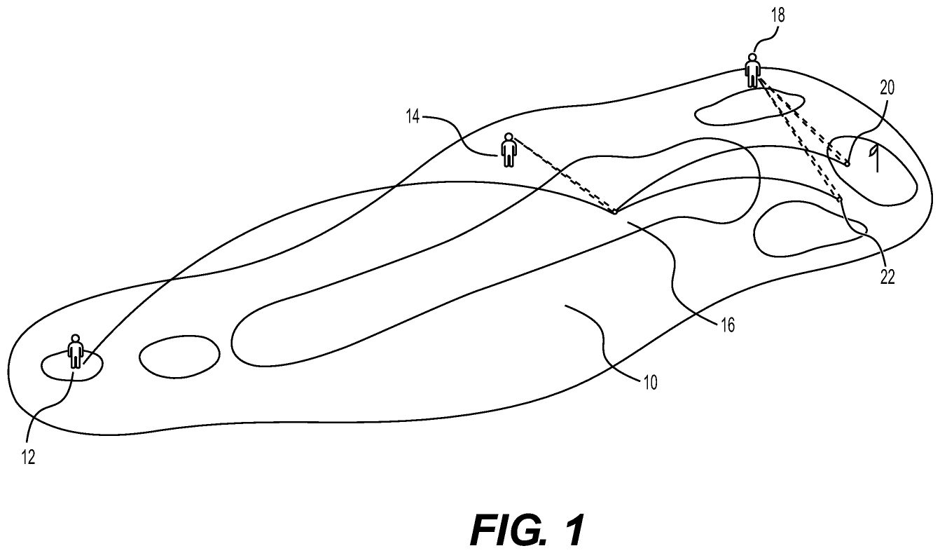

FIG. 1 is a perspective view of an example of a golf hole 10. A player 12 tees a ball and drives it so that the ball 16 stops in a fairway. A tracker 14 stands on the sideline with a view of the ball 16. In the ordinary progression of play, the player 12 will next hit the ball 16 toward the green and end up on or near the green as exemplified by the two ball locations 20 and 22. A second tracker 18, in this example, has a clear view of the ball 20 or 22. Using the method and apparatus described herein, the location of the ball 16, 20 or 22 is determined by accurate latitude and longitude coordinates.

The description of the system and method utilizes some terms that are helpful to be defined. The following is a glossary of some of those terms.

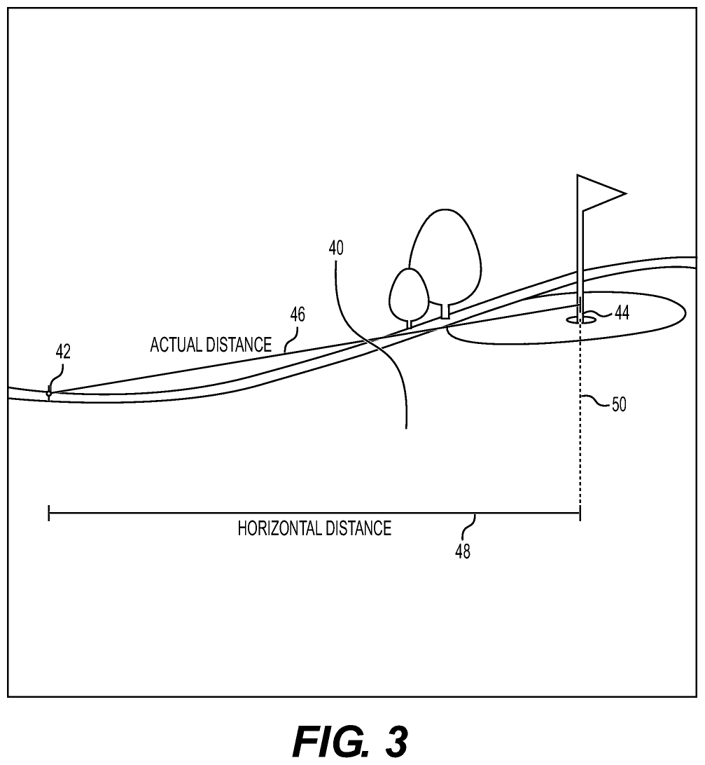

1. Trackers—Operators of the smart device that runs the software application that guides the tracker through the location process and that makes the calculations necessary to locate the object/golf ball with an accurate latitude and longitude. The tracker is referred to throughout as a person, however, it is possible to deploy a robot that has the ability to remotely locate the ball on the golf course and run the software application automatically. At least one drawback of the use of robots would be cost and the need for human oversight of their operation.
2. Ball Distance—The horizontal distance between the smart device running the software application and where the ball has landed. This distance, also sometimes referred to as slope distance, is determined by a commercially available rangefinder that accounts for elevation changes to return the horizontal distance. FIG. 3 illustrates an uneven golf hole 40 where the flag 44 is above the ball 42. The horizontal distance 48 is shown versus the actual distance 46 that a person might walk from the ball 42 to the flag 44. The height difference 50 illustrates the extra height of the flag 44 over the ball 42.
3. Smart Device Location—Latitude and Longitude of the smart device running the software application and that is carried by a tracker. These location coordinates are determined by a GPS enabled smart device that includes many or most of smart devices currently commercially available.
4. Compass Bearing—Compass reading in degrees from 1-360 between the tracker smart device and the ball as measured by the internal compass inside a smart device that measures bearing versus the Earth's magnetic north. Sometimes referred to as the heading, this is the direction in which a person would need to travel to reach a destination point. This measurement is automatically collected by the software application in the smart device.
5. Magnetic Declination—The angle between Geographic North and Magnetic North. This calculation is determined by the latitude and longitude of the smart device running the software application. This variable changes based on the latitude and longitude of the smart device, for example in the United States the Magnetic Declination can range anywhere from 20 to −11 degrees.
6. Geographic Bearing—A term similar to Compass Bearing but relative to Geographic North rather than Magnetic North. This value is determined by the application software by combining the already collected Compass Bearing and the Magnetic Declination.

The equipment needed to run the system herein includes a rangefinder, a smart device and the smart device application software. The rangefinder may be generally commercially available, but it may also be more sophisticated or custom designed for the location purposes described. The smart device must be GPS-enabled, and this may include commercially available smart phones or tablets or similar digital devices. The software application will be able to be installed and run by the smart device. The most easily assembled apparatus will include commercially available products where the rangefinder and smart device are separate components. It is possible that a smart device may be engineered and equipped to have a range finding function, thereby resulting in a single component to serve both functions. Similarly, a range finder may be designed to have a processor to run the software application and a user interface to input needed information. These combined devices are not commercially available today, but they may be developed in the future.

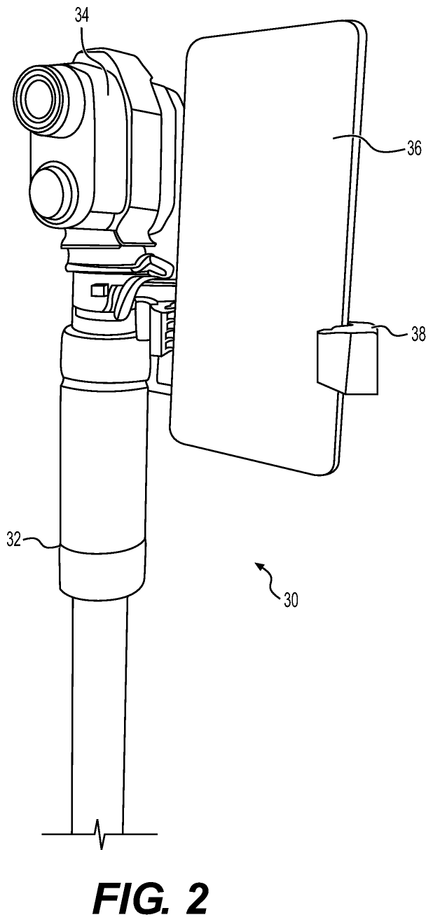

In FIG. 2, a tracker apparatus 30 includes a monopole 32 which has a rangefinder 34 mounted on top of the monopole and a smart device 36 secured on a mount 38 adjacent the range finder. This is an example of a simple tool that may be used to carry out the method set forth here.

In one example of the method and apparatus, the latitude and longitude of a golf ball is determined with the use of a custom-built software application running on a GPS enabled smart device in combination with a commercially available range finder. These two are combined to determine the variables needed to mathematically determine the ball's latitude and longitude after it lands on the course with an accuracy of less than 2 meters of the ball's actual location. Once the location of the ball is determined, the findings along with participant identifying information may be sent in real time to a cloud-based application or other central data collection processor. This central data collection processor may be proximate a golf course, for instance at the location of a golf tournament. Alternatively, the central data collection processor location may be remote as in the example of a cloud-based processor.

The goal of the method and apparatus is ultimately to provide the latitude and the longitude of the ball after it lands on the golf course with an accuracy of less than 2 meters. The tracker must be able to do his without entering the field of play, meaning a tracker must be able to determine the Latitude and Longitude of the ball while also remaining 25-100 yards, or alternatively 5-200 yards, away from the ball. Latitude and Longitude are a system of lines used to describe the location of any place on Earth. Lines of latitude run in an east-west direction across Earth. Lines of longitude run in a north-south direction. All mapping capabilities and positioning of real-world objects on earth is done leveraging the Latitude and Longitude system.

The following is a brief summary of the method steps described herein.
1. Tracker Location and Preliminary Inputs—After a golf ball has landed on the ground, a Tracker moves to where they can visually see the ball. At this point, the Tracker will enter information about the participant who hit the ball—name, stroke number, and other customizable fields. During this time the smart device will determine the location of the Tracker and the smart device.
2. Ball Distance—Next, the Tracker will be asked by the software application via the smart device user interface to use the Range Finder to determine the Ball Distance after which, the user will either type the variable into the app or it will be transmitted via Bluetooth to the smart device app.
3. Compass Bearing—The Tracker will then be prompted to lift the smart device running the software application and leveraging the camera center the ball within the visual prompts on the application. During this time, the software application using the smart device capabilities will be capturing the Compass Bearing. The software then automatically calculates the Compass Bearing by fusing together readings from the smart device's Magnetometer, Gyroscope, and Accelerometer.
4. Magnetic Declination—The software application will then leverage the smart device/Tracker Location to determine the Magnetic Declination.
5. Geographic Bearing—The software application then will use the newly collected Compass Bearing and Magnetic Declination to determine the Geographic Bearing of the ball relative to Geographic North.
6. Ball Location, Latitude and Longitude—Finally, the software application will combine the smart device/Tracker Location, Geographic Bearing, and Ball Distance to calculate the Latitude and Longitude of the golf ball and the results will be presented to the Tracker on a Map where they can then approve the findings before the collected data is sent to a central Cloud-Based Application (central data collection processor).

Each of the foregoing steps will now be discussed in more detail. For simplicity purposes, all the illustrative diagrams are displayed on a 2D graph rather than a spherical globe.

Tracker Location: Latitude and Longitude of the smart device running the application software, and also the location of the tracker holding the smart device. In short, this location is essentially the latitude and longitude of where the tracker is standing. This point is provided by a GPS on the Smart Device. GPS Technology has become more accurate over the years and the present method leverages this existing technology to provide this point location.

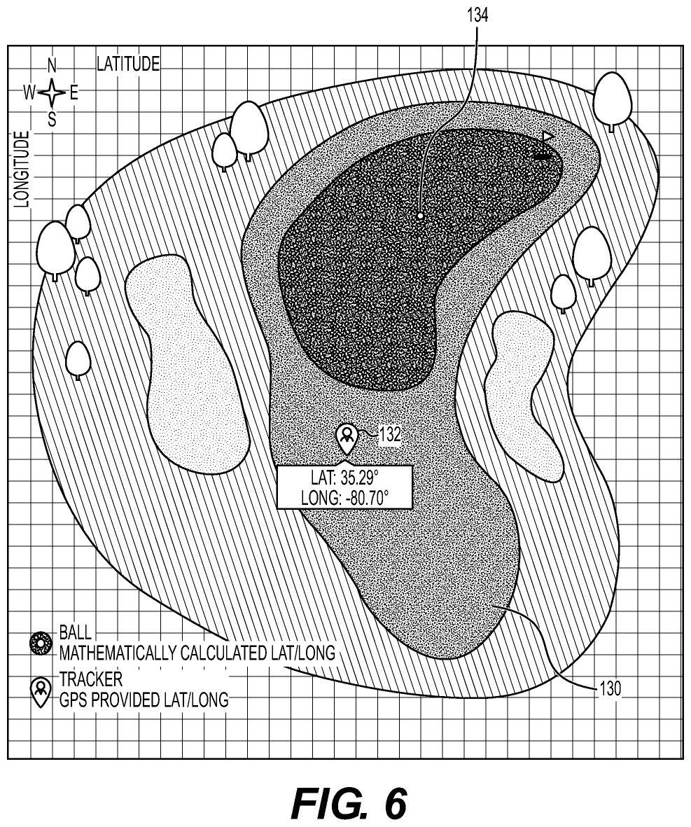

FIG. 6 illustrates a sample course hole 130 with a tracker 132 standing on the hole and the golf ball 134 located on the green. The tracker 132 has its latitude and longitude shown as provided by the GPS in the smart device held by the tracker.

With GPS coordinates alone, all that is known is where the tracker is standing. The tracker may be able to see the ball, but if the tracker were asked what the latitude and longitude of the ball was, they wouldn't be able to provide it. If allowed, the only way for the Tracker to determine the latitude and longitude of the ball with a GPS enabled device alone, would be for them to walk directly over to the ball and hold the GPS device on top of the ball. However, the trackers are not allowed to enter the field of play and must remain a remote distance away from the ball (usually 25-100 yards, or alternatively 5-200 yards away).

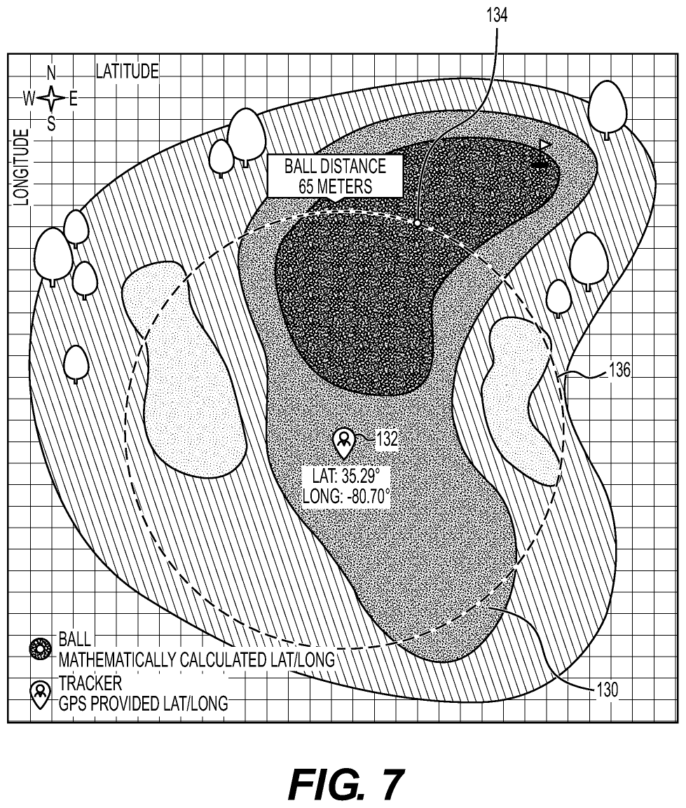

Ball Distance: Distance between the smart device and where the ball has landed. This is the Horizontal Distance to the ball compensating for elevation changes to return the true distance, also commonly referred to as Slope Distance. The horizontal distance is essentially the distance between the ball and the tracker. This distance is provided assuming the ball and the tracker are level to one another. If the ball and the tracker are not level to one another (ball is downhill or uphill from the tracker) the Range Finder will calculate the horizontal distance. FIG. 7 illustrates again the course hole 130 and the tracker location 132. The ball 134 has been determined by a rangefinder to be, in this example, 65 yards away as shown by the circle 136. At this point, the latitude and longitude of the tracker is known and how far away the ball is from the tracker is known, however, it is still not possible to provide the latitude and longitude of the ball. This could be compared to the childhood game of pin the donkey. You are told to walk 10 paces away from the wall, then someone blind folds you and spins you in circles, and then finally asks you to pin the tail on the donkey. The good news is you know the donkey is only 10 paces away, but in which direction? This is visualized in FIG. 7. With what is known, the ball could be on any point along the circle.

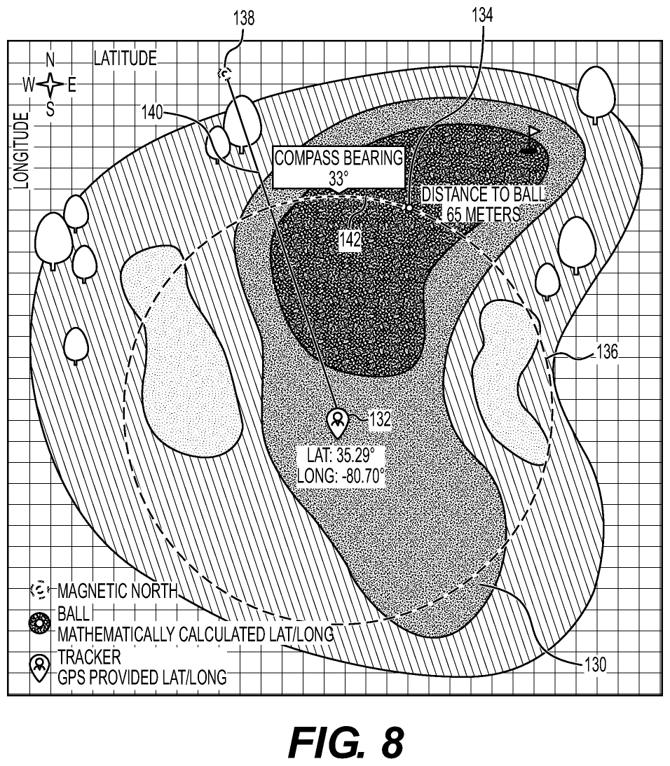

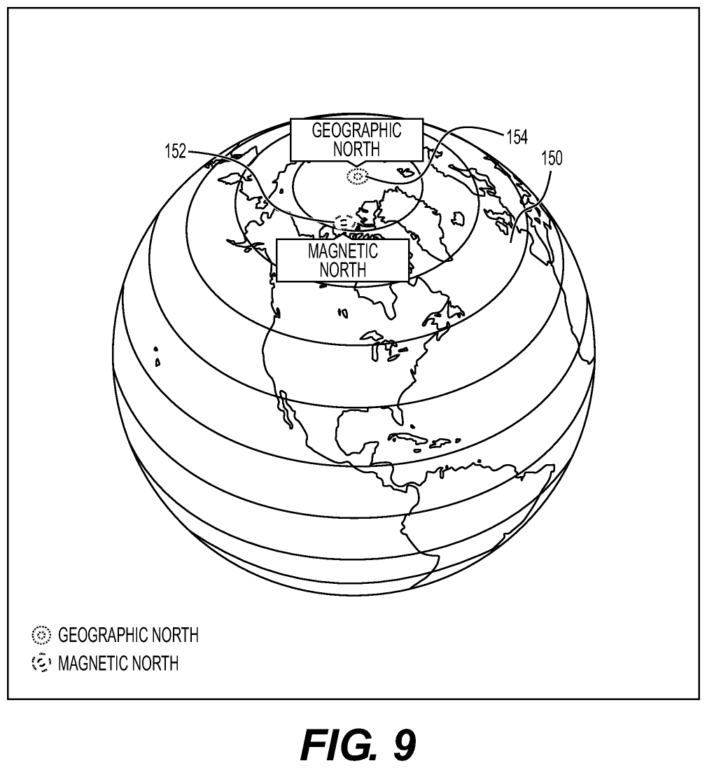

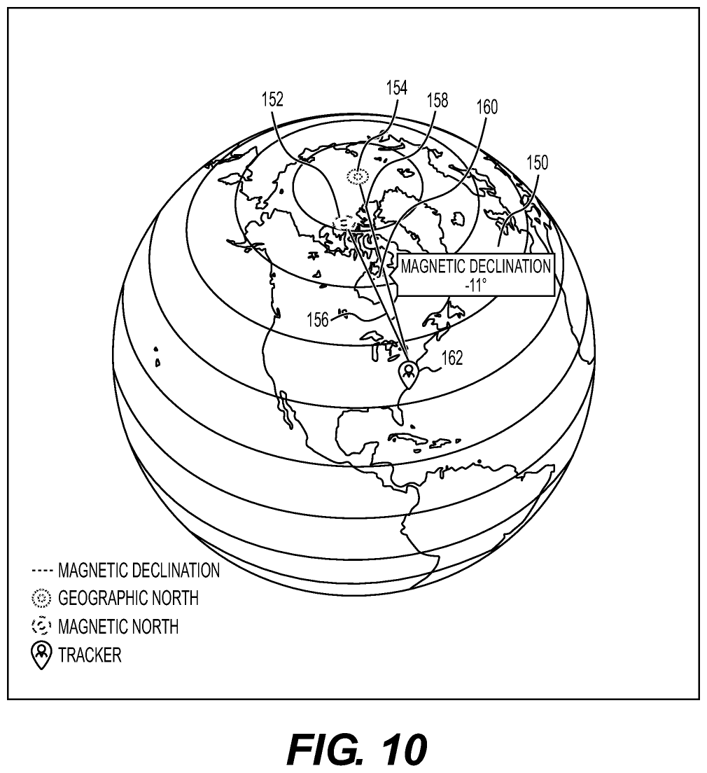

Compass Bearing: Compass reading, taken by the smart device internal compass, in degrees from 1-360 between the smart device and the ball. Sometimes referred to as the heading—the direction in which one would need to travel to reach a destination point. This is essentially the angle that the tracker would need to travel to find the ball relative to magnetic north. Magnetic North is the point on the earth at which a compass such as found in a smart device orients itself with. FIG. 8 shows the course hole 130, tracker 132, the ball 134 and the point of magnetic north 138 that is detected by the smart device held by the tracker. From the line 140 that is straight between the tracker 132 and magnetic north 138, the smart device determines that the ball 134 is 33 degrees from magnetic north on the curve 142 which is the compass bearing. With this, there is nearly all the information needed in order to determine the latitude and longitude of the ball. GPS provides Tracker Location (Latitude and Longitude), the distance to the ball from the Tracker Location is known, and the direction of the ball relative to magnetic north is known. Unfortunately, the Latitude and Longitude system does not use Magnetic North as its most northern point, but it uses “True North” or the “Geographic North Pole”. FIGS. 9 and 10 illustrate the significant difference between magnetic north and geographic north. The earth 150 has a magnetic north pole 152 and a geographic north pole 154. In FIG. 10, an example tracker 162 is shown on the East Coast of North America. The line 156 between the tracker 162 and magnetic north 152 is −11 degrees off from the line 158 between the tracker and geographic north 154. This −11 degree difference is referred to as the magnetic declination 160. Since a compass leverages the earth's Magnetic North Pole, at this point all that is known is the general direction of where the ball is located. There can be a sizeable distance between Magnetic North and Geographic North. Also, depending on where a tracker is standing on the earth, the difference in direction of those two points may be quite different. For example, if a person was positioned on the Eastern US Coast on the above globe, True North would be slightly to the right of Magnetic North, however, if you were on the Western US Coast, Geographic North would be to the Left of Magnetic North.

Magnetic Declination: The angle between Geographic North and Magnetic North determined by the latitude and longitude of the smart device/tracker. This angle changes based on the latitude and longitude of the smart device, for example in the United States the Magnetic Declination can range anywhere from 20 to −11 degrees. This was described above when comparing the relation of Magnetic North and Geographic North from the East and West Coasts. In FIG. 9, the Magnetic Declination is the angle between the two lines. Since the current apparatus can be used anywhere in the world, the lines would change based on where the apparatus is being used. With this in mind, the Magnetic Declination has to be calculated every time the apparatus is used to ensure adjustments are made based on the smart device/tracker location. Magnetic Declination calculations are straight forward. Since the Geographic North Latitude and Longitude (0,0), the Magnetic North Latitude and Longitude (72.68° W, 80.65° N) are known and via the GPS the smart device/tracker Latitude and Longitude are known, a calculation can determine the angle between all three of these points. Now that the Magnetic Declination is known, it is possible to combine this with the Compass Bearing to determine the Geographic Bearing.

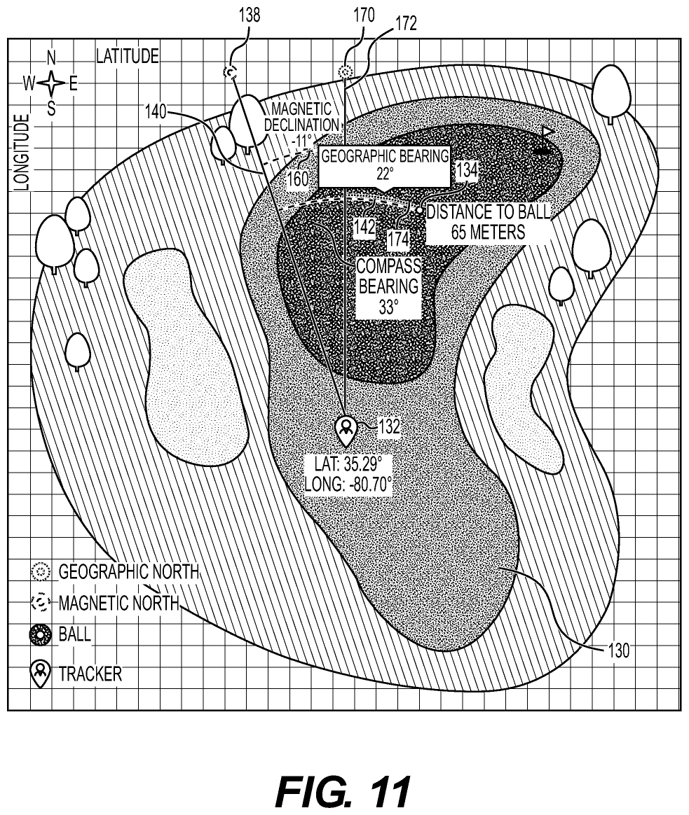

Geographic Bearing: A term similar to Compass Bearing but relative to Geographic North rather than Magnetic North. In short, the Geographic Bearing is a term that is referring to the Compass Bearing added to the Magnetic Declination to return the angle between True North and the ball. This is important as True North is what is leveraged on the Latitude and Longitude Coordinate System. For example, if the Compass Bearing between the Tracker and the Ball is 110 degrees, and the Magnetic Declination for where the Tracker is located is 11 degrees, the Geographic Bearing is 121 degrees. The resulting 121 degrees is the direction relative to true north that one would need to travel to find the Latitude and Longitude of the ball. This is the final point needed to determine the Latitude and Longitude of the Ball. FIG. 11 illustrates the example determination of a geographic bearing. The line 140 from the tracker to magnetic north 138 is −11 degrees different (the magnetic declination 160) from the line 172 between the tracker and geographic north 170. Therefore, the geographic bearing 174 between geographic north 170 and the golf ball 134 is 22 degrees.

With all this information, it is known precisely how far the ball is away from the smart device/tracker location and in what direction. These variables are then used to run a trigonometry equation which will result in the Latitude and Longitude of the ball.

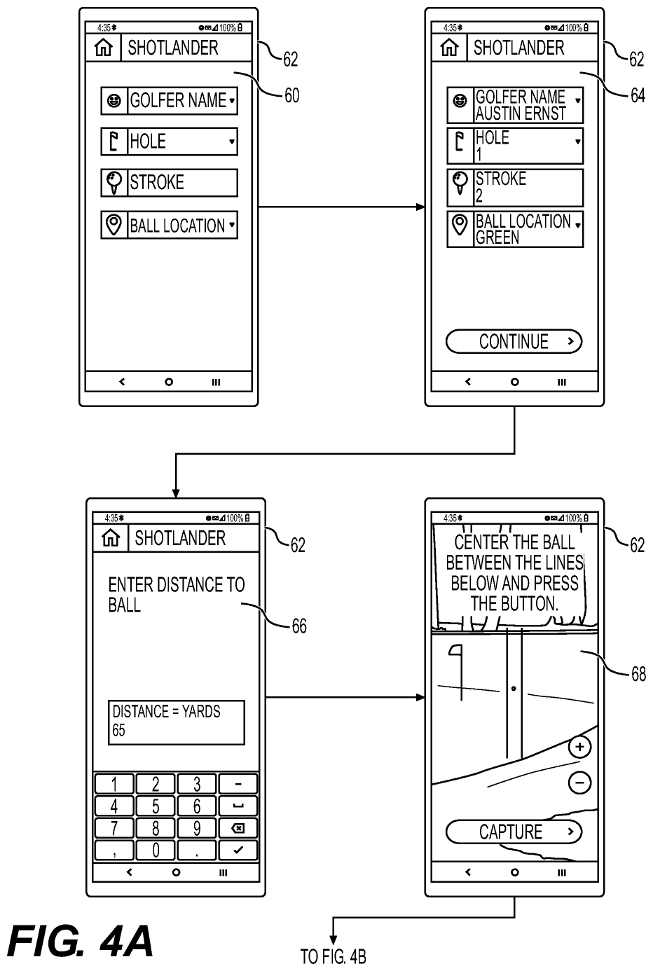

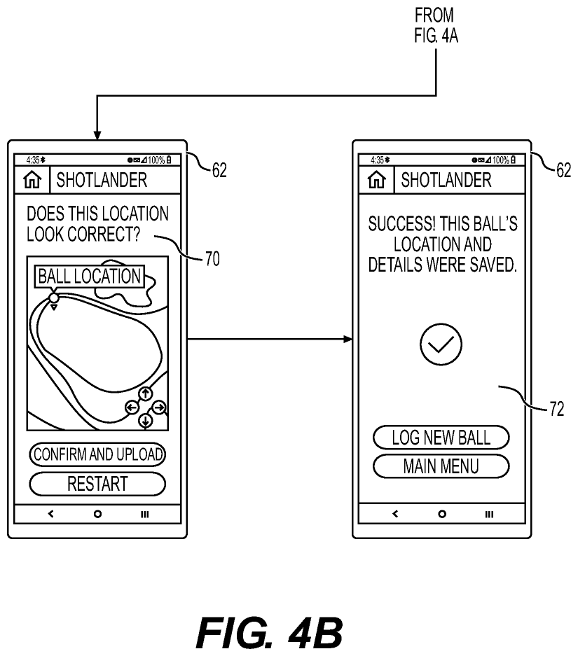

FIGS. 4A and 4B illustrate an example of the user interface 60 on a smart device 62 that is running the software application. User interface 60 illustrates in this example four questions that are presented to a tracker locating a ball on the course. User interface 64 illustrates an example with the four questions answered by the tracker. User interface 66 asks the tracker to enter the distance ball as read from a rangefinder. User interface 68 leverages the smart device compass in locating the ball on the course near the tracker. Finally, as a quality confirmation check, the user interface 70 asks the tracker to confirm that the reported location of the ball on the course is visually accurate. Once confirmed, user interface 72 notifies the tracker of success in locating the ball.

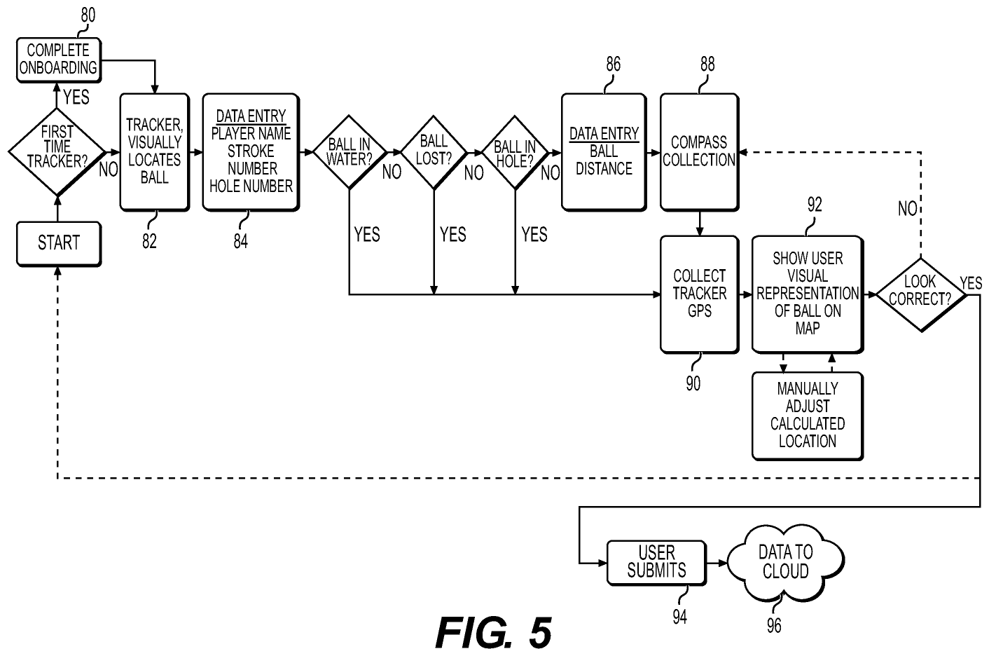

FIG. 5 is a flowchart of the functional operation of the software application that runs the apparatus and facilitates the method herein. This is one example of how the software could function. Other variations could surely reach the same information and accurate ball location using the same input information and geographic guidelines.

Turning now to the FIG. 5, a user is registered in the software application through an onboarding step 80. Whether previously registered or newly registered, a tracker will next visually locate a ball after it has landed on the ground in step 82 including moving to a location where the ball can be seen. In step 84, the tracker will enter information about the player name, shot number and hole number. If the ball is lost or goes into a hazard, the tracker will log a stroke and restart the process on the next shot. If the ball is in the hole, the user/tracker will count the stroke and move to the next hole (if they are following a particular player). A tracker may follow a specific individual player. A tracker may follow and log locations for a group of two or more players. Or, a tracker may be station on a specific hole to log shot locations of all the players that are playing through that hole. Once the ball is located, in the next step 86 the tracker/user will use a rangefinder to determine the Ball Distance after which the user will either type the variable into the software application or it will be transmitted to the app via Bluetooth. The tracker will then in the next step 88 be prompted to lift the smart device running the software application and, leveraging the camera, center the ball within the visual prompts on the application. During this time, the software application will be capturing the Compass Bearing. The software calculates the Compass Bearing by fusing together readings from the smart device's Magnetometer, Gyroscope, and Accelerometer. The software will leverage the tracker location to determine the Magnetic Declination. The software will use the newly collecting Compass Bearing and Magnetic Declination to determine the Geographic Bearing of the ball relative to. Geographic North. In step 90, the application software will combine the Tracker Location, Geographic Bearing, and Ball Distance to calculate the Latitude and Longitude of the Ball. In step 92, the location results will be presented to the Tracker on a Map, and if the ball location does not look correct, the user may adjust the calculated location or retry. If correct, in step 94, the tracker/user can then approve the findings. Once approved, in step 96, the collected data is sent to a Cloud-Based Application (central data collection processor).

Other variations of the system and process described herein are possible as described in the following alternative examples. Still further variations are possible.

### Alternative Example 2

In this version of the method and apparatus disclosed herein, the latitude and longitude location of the ball is determined with the use of a software application running on any smart device without the requirement for onboard GPS in the smart device that is required in the earlier example 1 discussed herein. In this example, the GPS location for the Tracker is gathered through a Range Finder that has the capability of capturing the tracker's location. This location found through the Range Finder is then transmitted in real time to the Smart Device running the software so that it may be used in the same manner as the rest of the earlier example. Just as in the earlier example, these devices are combined to determine the variables needed to mathematically determine the ball's latitude and longitude after it lands on the course with an accuracy of less than 2 meters of the ball's actual location. Once the location of the ball is determined, the findings along with participant identifying information are sent in real time to a cloud-based application.

### Alternative Example 3

In this version, the latitude and longitude of the ball is determined with the use of an application running on any smart device without the requirement for onboard GPS OR Compass Sensors that are required in the earlier example 1. In this example, the GPS location for the Tracker is gathered through a Range Finder that has the capability of capturing the tracker's location. At the same point that the Ball Distance is captured, the Range Finder will also gather the tracker's Compass Bearing. This location and compass bearing found through the Range Finder is then transmitted in real time to the Smart Device so that it may be used in the same manner as the rest of example 1. Just as in example 1, these devices are combined to determine the variables needed to mathematically determine the ball's latitude and longitude after it lands on the course with an accuracy of less than 2 meters of the ball's actual location. Once the location of the ball is determined, the findings along with participant identifying information are sent in real time to a cloud-based application.

### Alternative Example 4

In this version, the latitude and longitude of the ball is determined with the use of a software application running on any smart device without the requirement for onboard GPS that is required in example 1. This example requires the use of known location markers preset throughout the course. These preset, known locations are points loaded into the application where the latitude and longitude are already known. Trackers then position themselves next to one of these known points so that the use of GPS is not required. Just as in example 1, a commercially available range finder is then used to capture the Ball Distance. Just as in example 1, these devices are combined to determine the variables needed to mathematically determine the ball's latitude and longitude after it lands on the course with an accuracy of less than 2 meters of the ball's actual location. Once the location of the ball is determined, the findings along with participant identifying information are sent in real time to a cloud-based application.

Other embodiments of the present invention will be apparent to those skilled in the art from consideration of the specification. It is intended that the specification and figures be considered as exemplary only, with a true scope and spirit of the invention being indicated by the claims.

That which is claimed is:

1. A method of accurately presenting the latitude and longitude of a golf shot location comprising the steps of:
providing a smart device that is GPS-enabled, has an internal compass, has a user interface, and comprises a processor that uses geocoordinates and distance measurements to calculate accurate golf ball location;
providing a rangefinder;
providing a tracker;
during a golf game, after a player hits a golf ball on the golf course;
identifying the latitude and longitude of the tracker on the golf course;
measuring the distance between the tracker and the golf ball on the course using the rangefinder;
obtaining the compass bearing in degrees from 1 to 360 between the ball and the smart device as measured by magnetic north using the compass in the smart device;
calculating by the processor the magnetic declination angle of the tracker between geographic north and magnetic north based on the known latitude and longitude of each of the geographic north, the magnetic north and the location of the smart device;
calculating by the processor the geographic bearing of the ball from the smart device by combining compass bearing and magnetic declination;
calculating by the processor the latitude and longitude location of the ball by using the distance of the ball and the geographic bearing of the ball from the smart device; and
displaying on the user interface of the smart device the latitude and longitude location of the golf ball.

2. A method of accurately presenting the latitude and longitude of a golf shot location as described in claim 1, further comprising the step of transmitting by the smart device the golf ball location to a central data collection processor.

3. A method of accurately presenting the latitude and longitude of a golf shot location as described in claim 2, wherein the central data collection processor is proximate the golf course.

4. A method of accurately presenting the latitude and longitude of a golf shot location as described in claim 2, wherein the central data collection processor is remote from the golf course.

5. A method of accurately presenting the latitude and longitude of a golf shot location as described in claim 1, wherein the calculated latitude and longitude location of the golf ball is visually displayed to the tracker and approved by the tracker before the location is saved.

6. A method of accurately presenting the latitude and longitude of a golf shot location as described in claim 1, wherein the rangefinder and smart device are separate physical components.

7. A method of accurately presenting the latitude and longitude of a golf shot location as described in claim 1, wherein the rangefinder and smart device are a single component.

8. A method of accurately presenting the latitude and longitude of a golf shot location as described in claim 1, wherein the rangefinder and smart device are mounted on a monopod.

9. A method of accurately presenting the latitude and longitude of a golf shot location as described in claim 1, wherein the smart device includes an application that displays to and prompts the tracker to complete tasks during the method steps.

10. A method of accurately presenting the latitude and longitude of a golf shot location as described in claim 1, wherein the tracker follows a single player around the entire golf course and saves the ball locations of all of the shots for that individual.

11. A method of accurately presenting the latitude and longitude of a golf shot location as described in claim 1, wherein the tracker follows a group of a plurality of players around the entire golf course and saves the ball locations of all of the ball shots for each player in the group.

12. A method of accurately presenting the latitude and longitude of a golf shot location as described in claim 1, wherein the tracker is stationed at a single location on the golf course and records the golf ball location of the shot of all the golf players proximate the single location.

13. A method of accurately presenting the latitude and longitude of a golf shot location as described in claim 1, wherein the tracker is human.

14. A method of accurately presenting the latitude and longitude of a golf shot location as described in claim 1, wherein the tracker is a robot.

15. A method of accurately presenting the latitude and longitude of a golf shot location as described in claim 1, wherein the processor has a map of a golf course stored therein, and the golf ball location is displayed on the map of the golf course.
